(19) United States
(12) Patent Application Publication
(10) Pub. No.: US 2002/0083555 A1
(43) Pub. Date: Jul. 4, 2002

(54) Damper hinge

(76) Inventor: Naokazu Suzuki, Yokohama (JP)

Correspondence Address: MORRISON LAW FIRM, 145 North Fifth Avenue, Mt. Vernon, NY, 10550, US

(21) Appl. No.: 09/999,411

(22) Filed: Oct. 31, 2001

(30) Foreign Application Priority Data
Oct. 31, 2000 (JP) 2000 332338

(51) Int. Cl. E05D 11/08

(52) U.S. Cl. 16/340

(57) ABSTRACT

A damper hinge to be used for opening/closing an opening/closing body, particularly such as a toilet seat and a toilet cover of a Western-style toilet and so on, comprising a case attached to a body part; a rotary shaft passing through a center part of the case in an axial direction and including a fixing portion for the opening/closing body in a projecting part thereof which projects from the case; a single or a plurality of brake disc(s) attached to the rotary shaft to be rotatable with the rotary shaft; a plurality of friction members disposed on both sides of the brake disc to sandwich and pressure-contact the brake disc with the rotary shaft, which is fixably accommodated inside the case, rotatably inserted through insertion holes formed in center parts thereof; pressure-contact force adjusting means for adjusting a pressure-contact force between each of the friction members and the brake disc; and a lubricant filled in pressure-contact/sliding parts of the brake disc and the friction members.

### BACKGROUND OF THE INVENTION

1. Field of the Invention

The present invention relates to a damper hinge to be used for opening/closing an opening/closing body, particularly, such as a toilet seat and a toilet cover of a Western-style toilet, and more particularly, to a damper hinge which is appropriate for use to hold the opening/closing body in its self-standing state and to prevent the opening/closing body from dropping rapidly at the time of closing.

2. Description of Related Art

Conventionally, a toilet seat and a toilet cover of a Western-style toilet are attached to the rear part of a toilet body by an opening/closing hinge to open and close freely relative to the toilet body. However, they drop rapidly, particularly, at the time of closing so that the toilet seat collides with the toilet body and the toilet cover collides with the toilet seat to make a big noise. In view of this problem, an opening/closing hinge with a fluid damper having a damper function for preventing the rapid drop of the toilet seat and the toilet cover is generally known, for example, as disclosed in Japanese Patent Laid-open No. 63-38423.

Meanwhile, this opening/closing hinge with the fluid damper, though having the damper function for preventing the rapid drop of the toilet seat and the toilet cover, requires another means to hold the toilet seat and the toilet cover in their self-standing state. In view of this problem, an opening/closing hinge with a cam mechanism in which the fluid damper and a compression spring are operated is generally known, for example, as disclosed in Japanese Patent Laid-open No. 10-205568 and Japanese Patent Laid-open No. 10-201669.

The conventionally known opening/closing hinges as described above both have a disadvantage that their structures are complicated to increase manufacturing cost.

It is an object of the present invention to provide a damper hinge whose structure is simple and manufacturing cost is low and which is capable of holding an opening/closing body in its self-standing state, and more particularly, a damper hinge appropriate to be used for opening/closing an opening/closing body, particularly, such as a toilet seat and a toilet cover of a Western-style toilet and so on.

### SUMMARY OF THE INVENTION

In order to achieve the above object, the present invention is characterized by that it comprises: a case attached to a body part; a rotary shaft passing through a center part of the case in an axial direction and including a fixing portion for an opening/closing body in a projecting part thereof which projects from the case; a single or a plurality of brake disc(s) attached to the rotary shaft to be rotatable with the rotary shaft; a plurality of friction members disposed on both sides of the brake disc to sandwich and pressure-contact the brake disc with the rotary shaft, which is fixably accommodated inside the case, rotatably inserted through insertion holes which are formed in center parts thereof; pressure-contact force adjusting means for adjusting a pressure-contact force between each of the friction members and the brake disc; and a lubricant filled in pressure-contact/sliding parts of the brake disc and the friction members.

The present invention is also characterized by that it comprises: a case attached to a body part; a rotary shaft passing through a center part of the case in an axial direction and including a fixing portion for an opening/closing body in a projecting part thereof which projects from the case; a single or a plurality of brake disc(s) attached to the rotary shaft to be rotatable with the rotary shaft; a plurality of friction members disposed on both sides of the brake disc to sandwich and pressure-contact the brake disc with the rotary shaft, which is fixably accommodated inside the case, rotatably inserted through insertion holes which are formed in center parts thereof; pressure-contact force adjusting means for adjusting a pressure-contact force between each of the friction members and the brake disc; and a lubricant filled in pressure-contact/sliding parts of the brake disc and the friction members, and is also characterized by that a plurality of small projections are radially disposed around the insertion hole on a sliding surface of each of the friction members which pressure-contact the brake disc.

In this case, the present invention may have a structure in which the plural small projections have different height from each other and click stopping portions composed of projecting portions or recessed portions are provided on both sides of the brake disc to control rotational torque of the rotary shaft which rotates with the brake disc.

The present invention may also have a structure in which the pressure-contact adjusting means is composed of an adjusting base body accommodated in an accommodating hole of the case with its movement in an axial direction being restricted, a pressure washer disposed between the adjusting base body and the friction member, and an adjusting screw attached to the adjusting base body with a tip thereof being in contact with the pressure washer to move the pressure washer in an axial direction.

### BRIEF DESCRIPTION OF THE DRAWINGS

FIG. 1 is a front view of a damper hinge according to the present invention;

FIG. 2 is a left side view of the damper hinge according to the present invention;

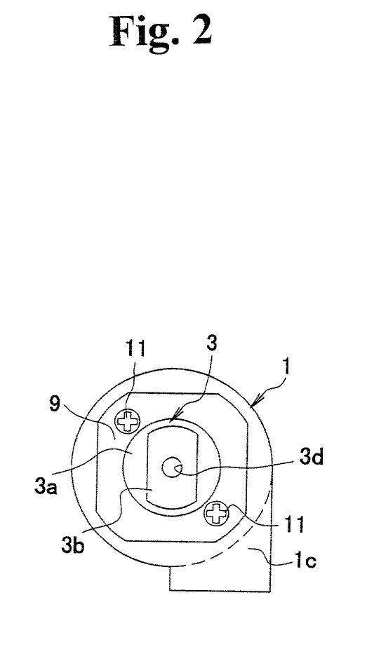

FIG. 3 is a right side view of the damper hinge in FIG. 1;

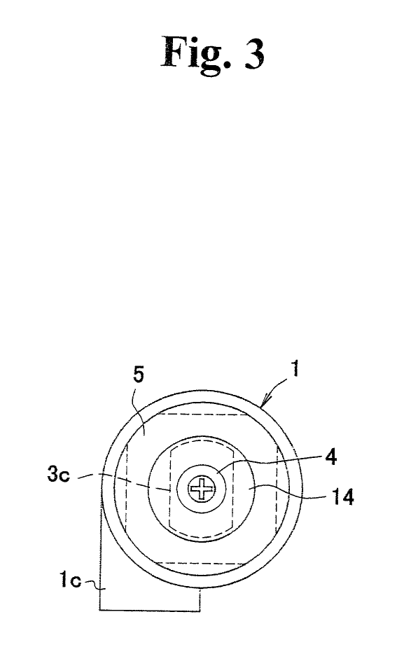

FIG. 4 is an exploded front view of the damper hinge in FIG. 1;

FIG. 5 is a vertical sectional view of a case;

FIG. 6 is a left side view of the case;

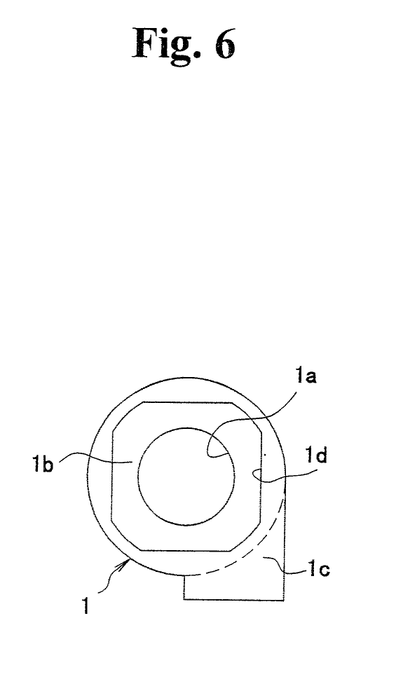

FIG. 7 is a right side view of the case;

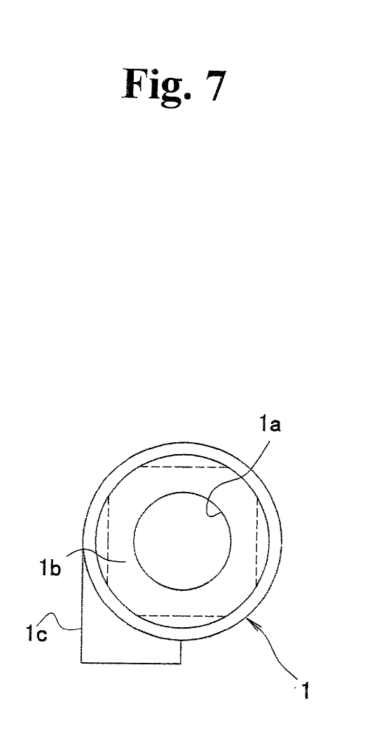

FIG. 8 is a front view of a brake disc;

FIG. 9 is a plan view of the brake disc;

FIG. 10 is a left side view of the brake disc;

FIG. 11 is a right side view of a friction member 7;

FIG. 12 is a sectional view of the friction member 7 taken along the A-A line in FIG. 11;

FIG. 13 is a sectional view of the friction member 7 taken along the B-B line in FIG. 11;

FIG. 14 is a left side view of a friction member 8;

FIG. 15 is a sectional view of the friction member 8 taken along the C-C line in FIG. 14;

FIG. 16 is a sectional view of the friction member 8 taken along the D-D line in FIG. 14;

FIG. 17 is a left side view of an adjusting base body;

FIG. 18 is a left side view of a pressure washer; and

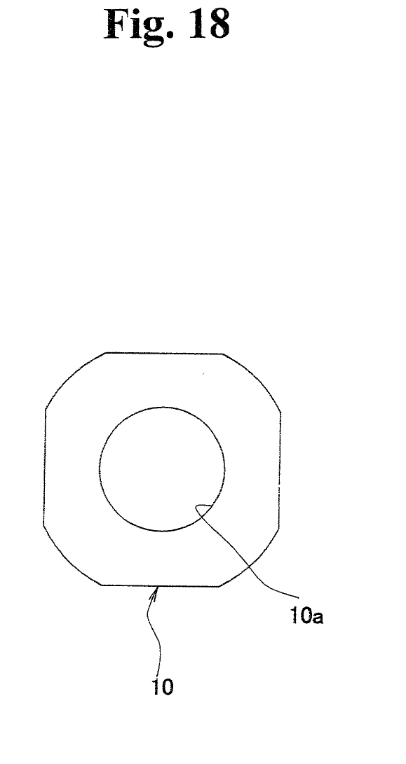

FIG. 19 is a right side view of the presser washer.

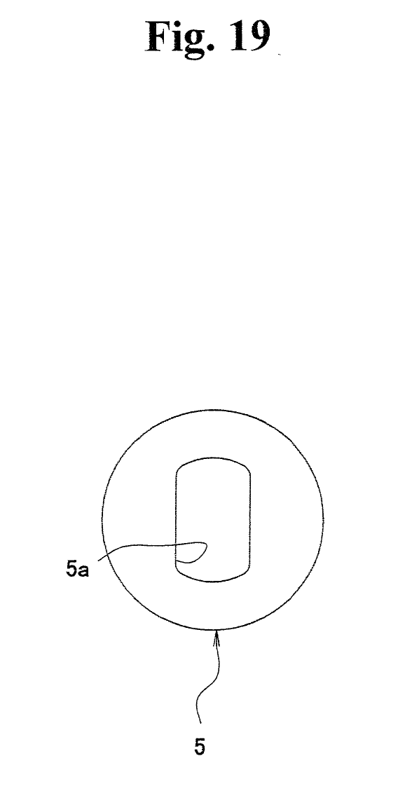

### DETAILED DESCRIPTION OF THE PREFERRED EMBODIMENTS

An embodiment of the present invention is explained below as an opening/closing hinge for a toilet seat and a toilet cover of a Western-style toilet. Besides being applied as the opening/closing hinge for the toilet seat and the toilet cover of the Western-style toilet, a damper hinge according to the present invention is widely applicable to an opening/closing body which requires a damper function at the time of opening/closing and which needs to be held in its self-standing state.

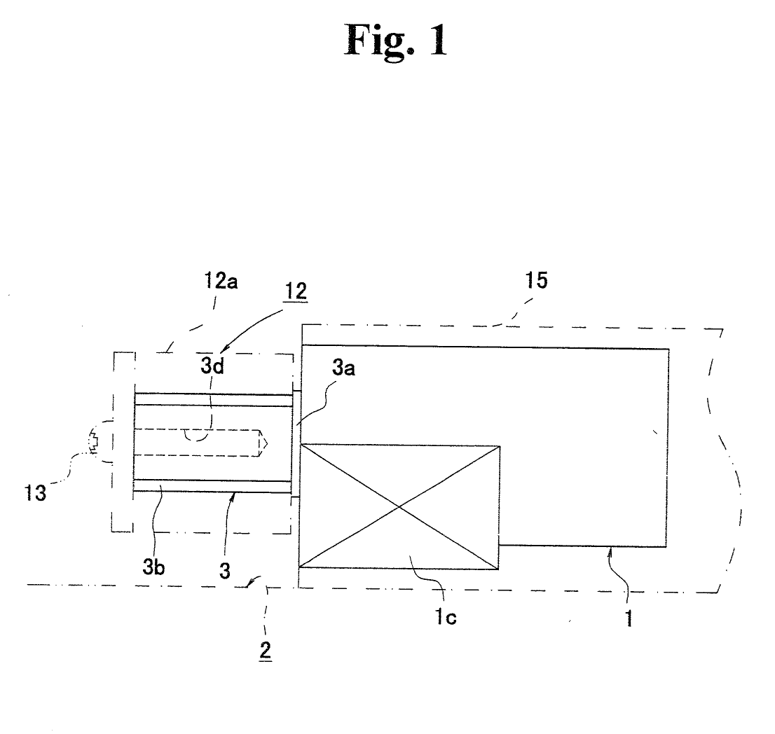

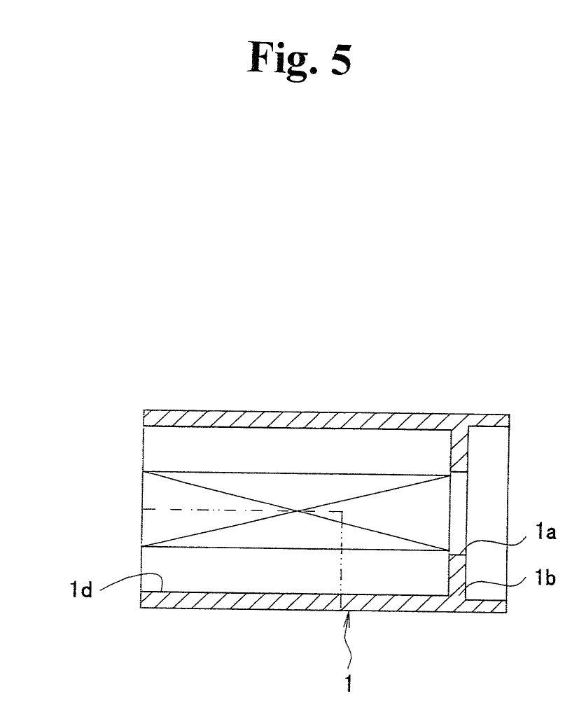

In the drawings, a reference numeral 1 denotes a case attached to a body part 2, for example, a toilet body of the Western-style toilet, and this case 1 is cylindrically shaped with one end part thereof provided with a wall portion 1b having a bearing hole 1a and the other end being open. Inside the case 1, an accommodating hole 1d with a substantially square sectional shape is formed, as particularly shown in FIG. 5 and moreover, as particularly shown in FIG. 1, in a lower part in one side part from a center part of the case 1, a fixing portion 1c is protrudingly provided to be attached to the body part 2 which is shown by the imaginary line.

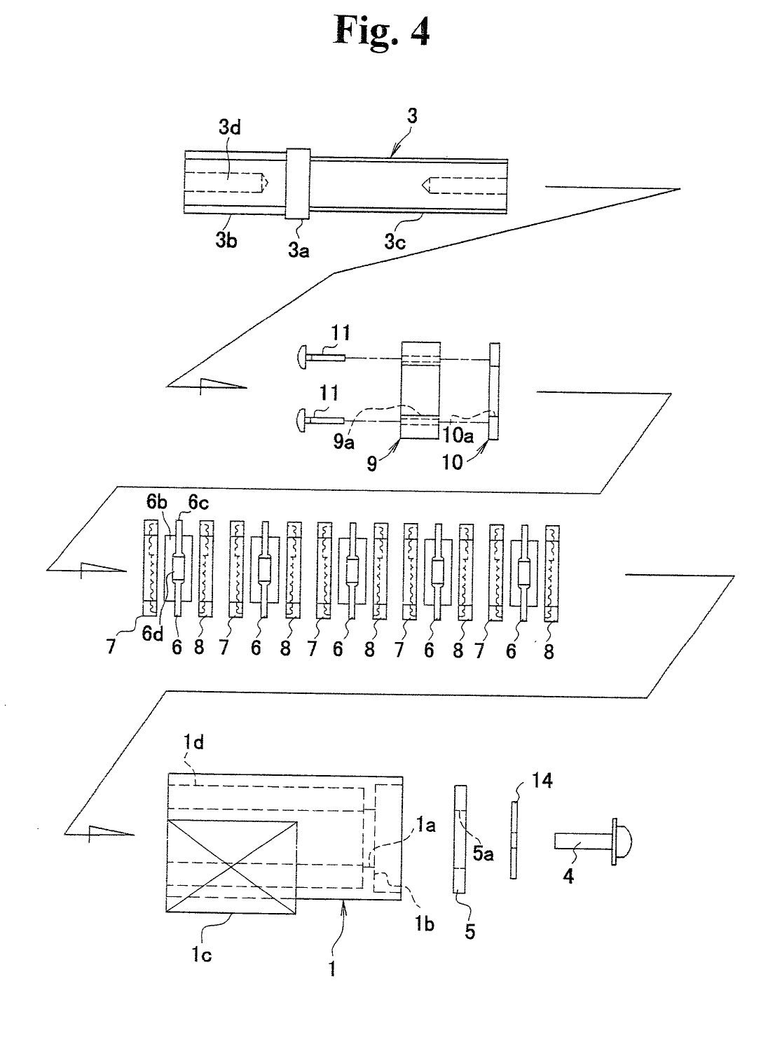

A rotary shaft 3 passes through a center part of the accommodating hole 1d of the case 1 in an axial direction and one end part of the rotary shaft 3 is pivotally supported in the bearing hole 1a which is provided in the wall portion 1b to rotate freely. The rotary shaft 3 has, as particularly shown in FIG. 4, a flange portion 3a in a position deviated to one side from a center part and shaft portions on both sides of the flange portion 3a are a fixing portion 3b and a shaft portion 3c respectively with sections thereof deformed to be substantially oval shapes. A presser washer 5 is attached to a part, which protrudes from the bearing hole 1a, of one end part of the rotary shaft 3 with the end of the shaft portion 3c of the rotary shaft 3 inserted to an engaging hole 5a which is formed in a center part of the presser washer 5 and which has a substantially oval-shaped plane surface. Thereby, the presser washer 5 is structured to be caught by the rotary shaft 3 to rotate with the rotary shaft 3. The presser washer 5 is screwed to the rotary shaft 3 by a fixing screw 4 attached to the end part of the rotary shaft 3 so as not to come off the rotary shaft 3. Furthermore, the rotary shaft 3 is caught by the wall portion 1b so that the rotary shaft 3 is prevented from coming off to an opening end side of the case 1. Note that the reference numeral 14 denotes a locking plate.

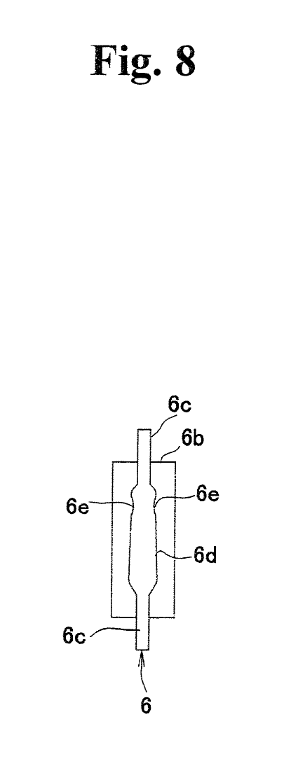

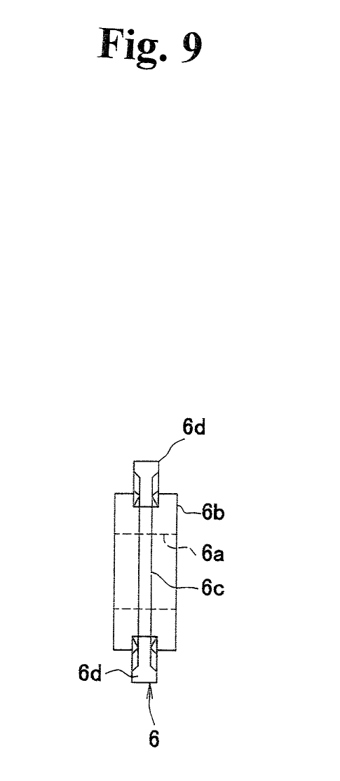

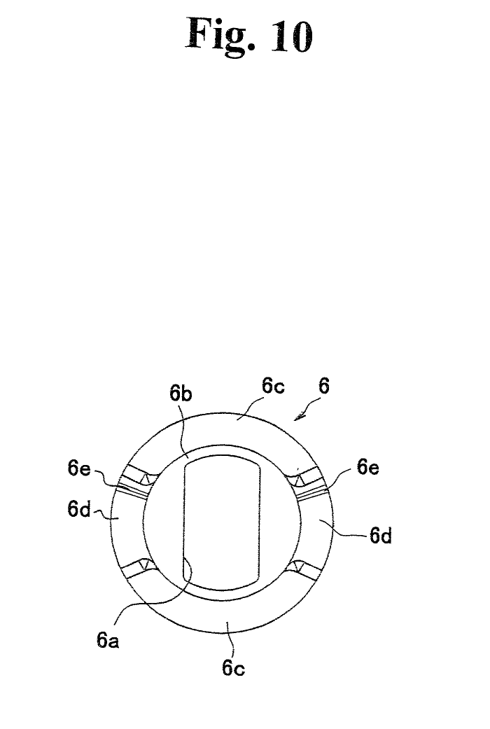

The reference numeral 6 denotes a brake disc. As particularly shown in FIG. 8 to FIG. 10, the brake disc 6, which is disc-shaped and made by, for example, PBT, is composed of a cylinder portion 6b which constitutes a part near a center part of the brake disk 6 and is provided with a deformed hole 6a in a substantially rectangular shape in a center part thereof in an axial direction and a thin portion 6c formed in a part outside the cylinder portion 6b. Thick portions 6d, 6d are disposed at a spaced interval of 180_< on both sides of the thin portion 6c to face each other and furthermore, click stopping portions composed of recessed portions 6e, 6e, 6e, 6e are provided in the thick portions 6d, 6d respectively. Incidentally, the click stopping portions may be composed of projecting portions.

Five brake discs 6 are used in the embodiment shown in FIG. 4. However, this number is not restrictive. In some cases, only one disc brake 6 is used. The shaft portion 3c of the rotary shaft 3 is inserted to the deformed hole 6a which is formed in the cylinder portion 6b so that each of the brake discs 6 is structured to be caught by the rotary shaft 3 to rotate with the rotary shaft 3.

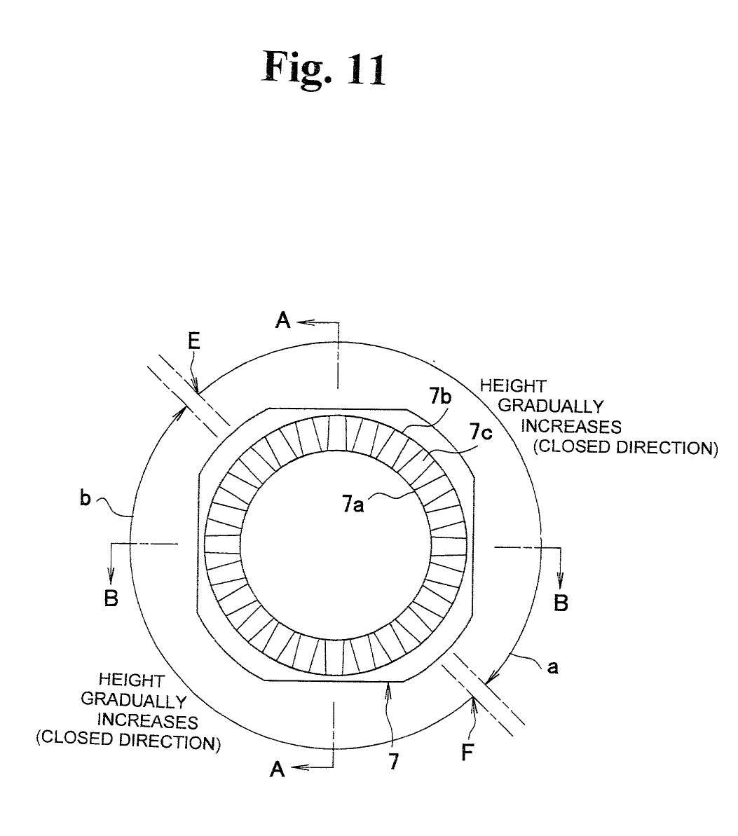

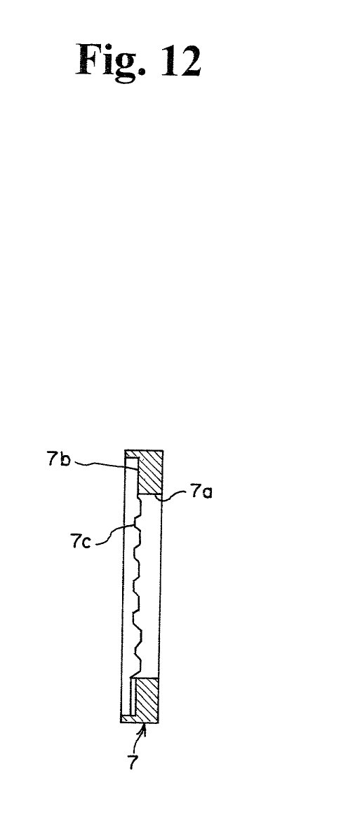

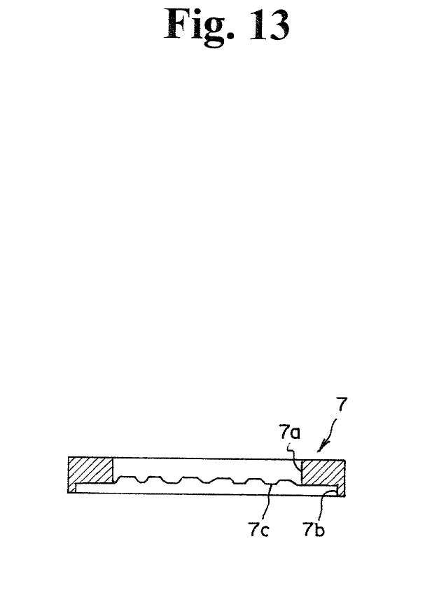

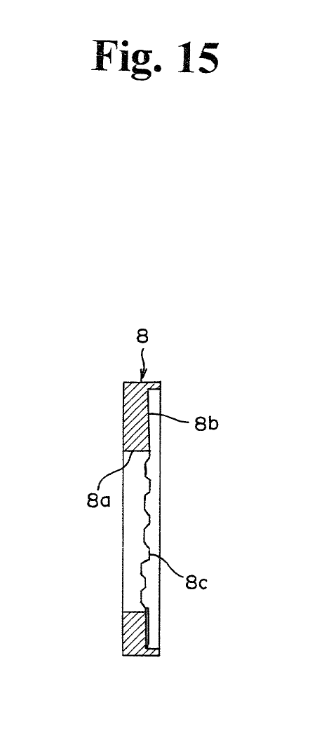

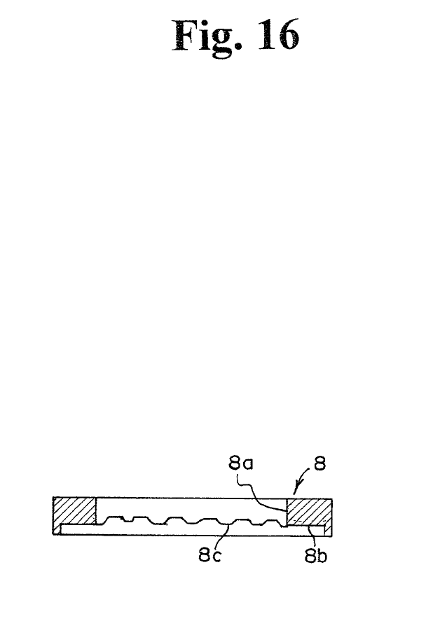

As shown in FIG. 4 and FIG. 11 to FIG. 16, friction members, which are denoted by the reference numerals 7, 8 and made of rubber, for example, NBR, have substantially deformed square shapes, when seen from side surfaces thereof, matching with the shape of the accommodating hole 1d of the case 1 to be accommodated fixably in the accommodating hole 1d. As shown in FIG. 11 to FIG. 13, the friction member 7 out of these friction members has an insertion hole 7a in a circular shape provided in a center part thereof in an axial direction and a hollow portion 7b provided to accommodate a half of the brake disc 6 in one side part thereof, and the hollow portion 7b has a plurality of small projections 7c, 7c . . . disposed radially around the insertion hole 7a in an inner bottom part thereof. The small projections 7c, 7c . . . are divided into two arrays as particularly shown in FIG. 11: one array having the small projections 7c, 7c . . . with their height gradually increasing from one starting point E in a direction of the arrow a up to a point approximately 180_< away from the starting point E and the other array having the small projections 7c, 7c . . . with their height gradually increasing from the other starting point F in a direction of the array b up to a point approximately 180_< away from the starting point F.

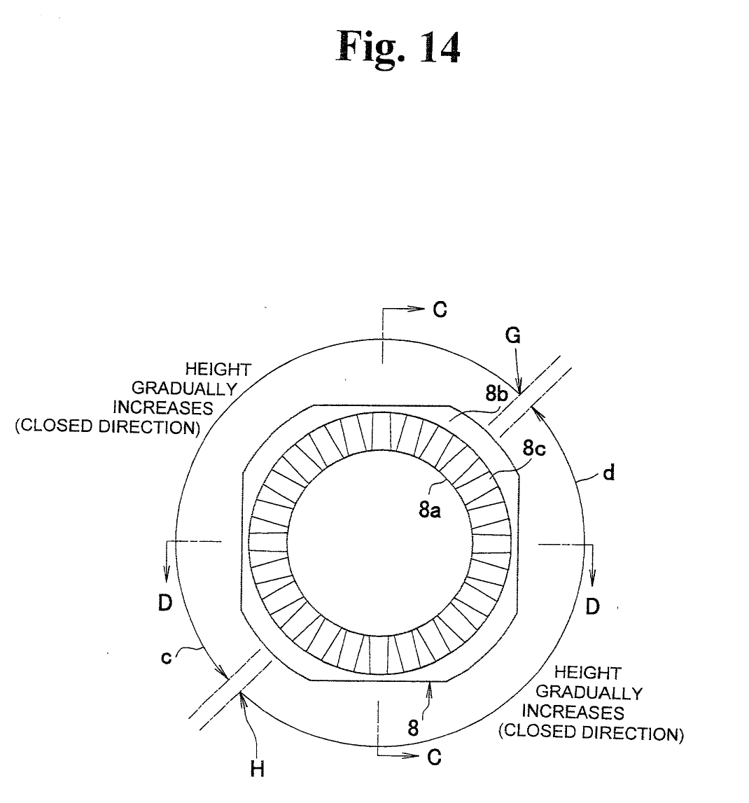

As shown in FIG. 14 to FIG. 16, the other friction member 8 has an insertion hole 8a in a circular shape formed in a center part thereof in an axial direction and a hollow portion 8b provided to accommodate a half of the brake disc 6 in one side part thereof, and the hollow portion 8b has a plurality of small projections 8c, 8c . . . disposed radially in an inner bottom part thereof. The small projections 8c, 8c . . . are divided into two arrays as particularly shown in FIG. 14: one array having the small projections 8c, 8c . . . with their height gradually increasing from one starting point G in a direction of the arrow c up to a point approximately 180_< away from the starting point G and the other array having the small projections 8c, 8c . . . with their height gradually increasing from the other starting point H in a direction of the arrow d up to a point approximately 180_< away from the starting point H.

In the embodiment shown in the drawings, five friction members 7 and five friction members 8, totally 10 friction members, are used as particularly shown in FIG. 4, but this number is increased/decreased depending on the number of the brake discs 6 used. Each pair of the friction members 7 and 8 accommodates the brake disc 6 between the hollow portion 7b and the hollow portion 8b to sandwich the brake disc 6 and each pair of the small projections 7c, 8c are formed to have inclinations with their height symmetrical with each other to form a tapered groove in a tapered shape. Note that a lubricant, for example, made from viscous grease, though not shown, is applied between the brake disc 6, particularly, the thick portions 6d, 6d and the plural small projections 7c . . . , 8c . . . of the friction members 7, 8 which pressure-contact the thick portions 6d, 6d from both sides.

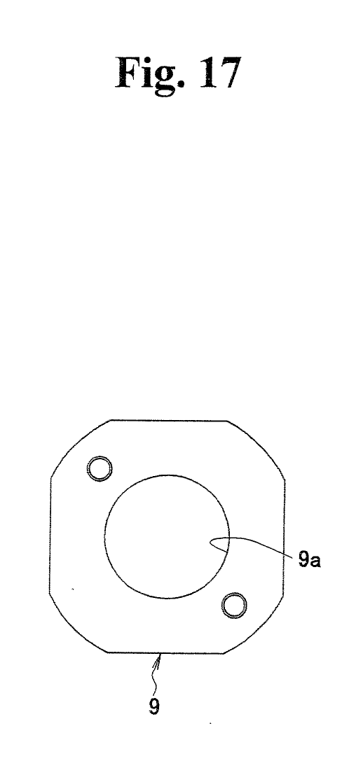

An adjusting base body, which is denoted by the reference numeral 9, has a substantially deformed square shape identical to the shape of the friction members 7, 8 when seen from a side surface thereof, as particularly shown in FIG. 17 and is structured to be fixed to the opening end side of the accommodating hole 1d of the case 1 with its rotation restrained. The adjusting base body 9 has a circular-shaped insertion hole 9a provided in a center part thereof in an axial direction and is disposed between the flange portion 3a and the left-end one of the friction members 7, having the shaft portion 3c of the rotary shaft 3 rotatably inserted to the insertion hole 9a thereof and being caught by the flange portion 3a of the rotary shaft 3 so as not to come off in an outer direction, as shown in FIG. 4. A pressure washer 10 is disposed between the adjusting base body 9 and the left-end one of the friction members 7 with the shaft portion 3c of the rotary shaft 3 further rotatably inserted through an insertion hole 10a in a substantially circular shape which is provided in a center part thereof, and tips of adjusting screws 11, 11 which are screwed to the adjusting base body 9 contact one side surface of the pressure washer 10 to work as pressure contact force adjusting means.

Therefore, when the damper hinge as structured above is used for opening/closing a toilet seat of a Western-style toilet, which is one example of the opening/closing body, the case 1 is fixably accommodated in a fixing case 15 which is attached to an upper end of a rear part of the body part 2 of the Western-style toilet as shown by the imaginary line in FIG. 1 and the fixing portion 12a of the toilet seat 12 shown by the imaginary line is fixed to the fixing portion 3b of the rotary shaft 3, which protrudes from the case 1. Incidentally, a male screw portion 3d provided in a center part of the fixing portion 3b of the rotary shaft 3 in an axial direction is for a bolt 13 used in fixing the fixing portion 12a of the toilet seat 12.

The case 1 maybe directly fixed to the body part 2 of the Western-style toilet, instead of being fixed via the fixing case 15. When the toilet seat 12 is opened/closed relative to the body part 2, the rotary shaft 3 rotates synchronously and the brake disc 6 which is caught by the rotary shaft 3 frictionally slides while being pressure-contacted between the friction members 7, 8 so that a damper function is caused at the time of closing the toilet seat 12 and a function of holding the toilet seat 12 in its self-standing state is caused at the time of opening.

More specifically, the thick portion 6d of the brake disc 6 moves inside the tapered groove which is formed by the inclinations given to the small projections 7c, 8c of the friction members 7, 8 which pressure-contact both sides of the thick portion 6d. When the thick portion 6d moves in a direction in which the tapered grove becomes narrower, the damper function at the time of closing the toilet seat 12 is caused. When the thick portion 6d moves in a direction in which the tapered groove becomes wider, the toilet seat 12 moves smoothly while moving through an intermediate angle. When the thick portion 6d is sandwiched between the projections with narrower space therebetween, the toilet seat 12 is stably held in its self-standing state while it is in a standing position.

Moreover, selection of height of the small projections 7c, 8c makes it possible to hold the toilet seat 12 in its stopping state at an intermediate opening angle, for example, approximately 70_< in a case of urination, when the toilet seat 12 does not necessarily need to be fully opened.

Furthermore, the click stopping portions composed of the recessed portions 6e are provided in the thick portions 6d so that the recessed portions 6e and the small projections 7c, 8c are engaged with each other when the toilet seat 12 is fully opened, which realizes click feeling and stable maintenance of its stopping state and enables a user to get the click feeling of the small projections 7c, 8c being released from the recessed portions 6e when the toilet seat 12 is closed from its fully open state.

Moreover, when the adjusting screws 11, 11 which are attached to the adjusting base body 9 are turned in either a left or a right direction, the pressure washer 10 moves in an axial direction to change a pressing force to the friction members 7, 8 so that friction torque of the rotary shaft 3 is freely adjustable.

What is explained above also applies to a case where the opening/closing body to be opened/closed is a toilet cover and so on and the damper hinge of the opening/closing body according to the present invention is applicable as an opening/closing hinge for the toilet cover.

The numbers of the friction members and the brake discs used are not limited to those in the embodiment described above and more of them are sometimes used. Alternatively, two friction members may be provided on each side of one brake disc or one friction member may be provided on one side of the brake disc.

Moreover, the friction member may be caught by the shaft to fix the brake disc to the case. As described above, the damper hinge according to the present invention is widely applicable for opening/closing an opening/closing body which needs to be stably held in its opening state and to be prevented from closing rapidly at the time of closing, as well as being applicable as the opening/closing hinge for the toilet seat and the toilet cover of the Western style toilet described above.

What is claimed is:

1. A damper hinge comprising:
a case attached to a body part;
a rotary shaft passing through a center part of said case in an axial direction and including a fixing portion for an opening/closing body in a projecting part thereof which projects from said case;
a single or a plurality of brake disc(s) attached to said rotary shaft to be rotatable with said rotary shaft;
a plurality of friction members disposed on both sides of said brake disc to sandwich and pressure-contact said brake disc with said rotary shaft, which is fixably accommodated inside said case, rotatably inserted through insertion holes which are formed in center parts thereof;
pressure-contact force adjusting means provided for adjusting a pressure-contact force between each of said friction members and said brake disc; and
a lubricant filled in pressure-contact/sliding parts of said brake disc and said friction members.

2. A damper hinge comprising:
a case attached to a body part;
a rotary shaft passing through a center part of said case in an axial direction and including a fixing portion for an opening/closing body in a projecting part thereof which projects from said case;
a single or a plurality of brake disc(s) attached to said rotary shaft to be rotatable with said rotary shaft;
a plurality of friction members disposed on both sides of said brake disc to sandwich and pressure-contact said brake disc with said rotary shaft, which is fixably accommodated inside said case, rotatably inserted through insertion holes which are formed in center parts thereof;
pressure-contact force adjusting means for adjusting a pressure-contact force between each of said friction members and said brake disc; and
a lubricant filled in pressure-contact/sliding parts of said brake disc and said friction members,
wherein a plurality of small projections are radially disposed around the insertion hole on a sliding surface of each of said friction members which pressure-contact said brake disc.

3. A damper hinge according to claim 2,
wherein the plural small projections have different height from each other and click stopping portions composed of projecting portions or recessed portions are provided on both sides of said brake disc to control rotational torque of said rotary shaft which rotates with said brake disc.

4. A damper hinge according to any of claims 1 through 2,
wherein said pressure-contact force adjusting means is composed of an adjusting base body accommodated in an accommodating hole of said case with its movement in an axial direction being restricted, a pressure washer disposed between the adjusting base body and said friction member, and an adjusting screw attached to the adjusting base body with a tip thereof being in contact with the pressure washer to move the pressure washer in an axial direction.
